(19) United States
(12) Patent Application Publication
(10) Pub. No.: US 2011/0298300 A1
(43) Pub. Date: Dec. 8, 2011

(54) Power Outlet for Air Conditioning Appliance and Method of Operation

(75) Inventors: Robin Gray, Brooklyn, NY (US); Vicki Kuo, Fort Lee, NJ (US)

(73) Assignee: CONSOLIDATED EDISON COMPANY OF NEW YORK, INC., New York, NY (US)

(21) Appl. No.: 12/794,339

(22) Filed: Jun. 4, 2010

(51) Int. Cl. H01H 35/00; F25D 3/00

(52) U.S. Cl. 307/116; 62/56

(57) ABSTRACT

A power outlet device for regulating the operation of an appliance, such as a window mounted air conditioner is provided. The device includes a power inlet and a power outlet coupled to a switch. A controller having a communications device controls the state of the switch. The controller is connected to a temperature sensor that measures the ambient temperature of the room. A user interface allows the user to define a maximum temperature for the room. In response to the receipt of a signal via the communications device, the controller regulates the flow of electrical power to the appliance based on the defined maximum temperature. A timer is also provided that minimizes short time period cycling of the appliance.

### BACKGROUND OF THE INVENTION

The subject matter disclosed herein relates to power outlet and in particular to a power outlet having a controller for regulating the operation of an appliance.

Air conditioning units, such as those mounted in windows, are a popular appliance that is broadly utilized during warm weather periods. These appliances are popular since they may be added to an existing space by a homeowner or apartment resident without need for contractors. This is especially advantageous where the space is rented and the lease prohibits modification of the structure. The appliances are also movable, allowing them to be installed when desired and removed when the tenant moves or during cooler weather conditions.

While air conditioning appliances are convenient for homeowners and tenants, these appliances consume a large amounts of electrical power. This may be especially problematic in large metropolitan areas having a high population density. While central or whole-building air conditioning system can be cycled (turning the compressor off while keeping the fan on to comfort) easily by building managers or utilities during peak demand periods, window or room air conditioners do not provide an easy way for utilities to control and offer an acceptable level of comfort to the users at the same time.

Accordingly, while existing appliance control systems are suitable for their intended purpose, there remains a need for improvements in coordinating control of a plurality of individual appliances during peak demand time periods and offer the adequate level of comfort to the users.

### BRIEF DESCRIPTION OF THE INVENTION

According to one aspect of the invention, a power outlet device is provided. The power outlet device includes a power inlet and a switch electrically coupled to the power inlet. The switch has a first open position and a second closed position. A power outlet is electrically coupled to the switch. A controller is operably coupled to the switch to selectively move the switch between the first position and the second position. A temperature sensor is operably coupled to the controller. A communications circuit is operably coupled to the controller.

According to another aspect of the invention, a power outlet device is provided. A switch is movable between a first state and a second state. A controller is operably coupled to the switch. A temperature sensor is operably coupled to the controller. A communications device is operably coupled to the controller. Wherein the controller includes a processor that is responsive to executable computer instructions when executed on the processor for moving the switch between the first state and the second state in response to a signal from the communications device when the temperature sensor measures a temperature less than a predetermined set point.

According to yet another aspect of the invention, a method of operating an air conditioning unit is provided. The method includes electrically coupling the air conditioning unit to a power outlet device having a switch arranged to electrically couple and decouple the window mounted air conditioning unit from an electrical circuit. A set point temperature is selected with a user interface on the power outlet device. An ambient temperature is measured with a temperature sensor on the power outlet device. A wireless command signal is received at the power outlet device. The air conditioning unit is decoupled from the electrical circuit with the switch in response to the wireless command signal when the measured temperature is less than the set point temperature.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a block diagram illustrating power outlet device in accordance with an exemplary embodiment of the invention;

FIG. 2 is a block diagram of the power outlet device of FIG. 1 coupled for communication to a home area network;

FIG. 3 is a block diagram of the power outlet device of FIG. 1 coupled for communication with an electrical utility meter; and,

FIG. 4 is a flow diagram illustrating a method for operating an air conditioning appliance.

The detailed description explains embodiments of the invention, together with advantages and features, by way of example with reference to the drawings.

### DETAILED DESCRIPTION OF THE INVENTION

Embodiments of the invention described herein provide advantages in controlling the operation of a plurality of air conditioning appliances using a power outlet device. Embodiments of the invention, when integrated with a Home Area Network (HAN), provide advantages in allowing an electrical utility or a building operator to implement demand response programs in residences using individually controlled window mounted air conditioning appliances. Embodiments of the disclosed power outlet device provide advantages in allowing a user to set a maximum temperature the conditioned space may achieve without the appliance operating. The disclosed power outlet device may provide further advantages in allowing the set point to be locally programmed or via a computer network. The disclosed power outlet device may provide yet further advantages in allowing a user to over-ride a demand response command.

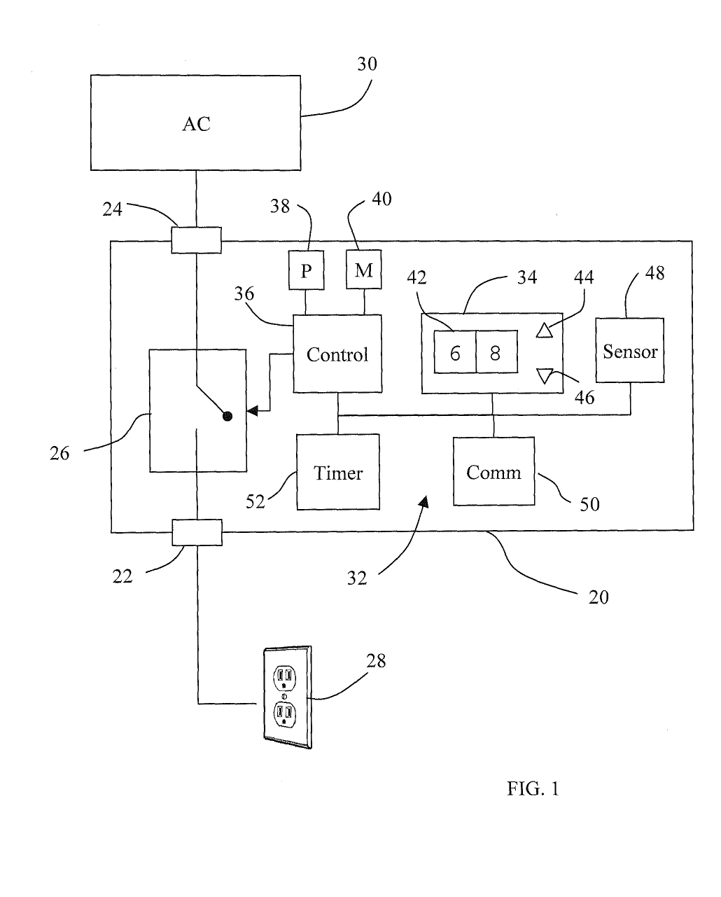

An exemplary embodiment of the power outlet device 20 is illustrated in FIG. 1. The power outlet device 20 includes a power inlet 22 that is configured to connect with a standard electrical wall outlet plug 28. In the exemplary embodiment, the power inlet is configured to connect with a National Electric Manufacturers Association (NEMA) type 5-15 wall outlet. The power inlet 22 is connected with a power outlet 24 by a relay or switch 26. The power outlet 24 is configured to receive the electrical power plug, such as a NEMA 5-15 plug for example, from an appliance 30 such as a window mounted air conditioning appliance for example.

The switch 26 may be any suitable device, such as a switch, a relay or a solid state device for example, capable of moving between a first state and a second state to electrically decouple and couple the appliance 30 from a source of electrical power. In the exemplary embodiment, the first state or open state is one where the appliance 30 is electrically decoupled from the wall outlet plug 28. The second state or closed state is one where the appliance 30 is electrically coupled to the wall outlet plug 28. It should be appreciated that when the switch 26 is in the first state, the appliance 30 will shut off and will not operate. In the exemplary embodiment, the switch 26 is configured to switch 120-240 Volts of electrical power.

The power outlet device 20 further includes a control device 32. The control device is a suitable electronic device capable of accepting data and instructions, executing the instructions to process data and storing the results. The control device may accept instructions and data through a user interface 34, or other means such as but not limited to electronic data card, voice activation means, manually operable selection and control means, radiated wavelength and electronic or electrical transfer. Therefore, the processor 38 can be a microprocessor, microcomputer, a minicomputer, an optical computer, a board computer, a complex instruction set computer, an ASIC (application specific integrated circuit), a reduced instruction set computer, an analog computer, a digital computer, a molecular computer, a quantum computer, a cellular computer, a superconducting computer, a supercomputer, a solid-state computer, a single-board computer, a buffered computer, a computer network, a desktop computer, a laptop computer, or a hybrid of any of the foregoing.

It should be appreciated that while the control device 32 is described herein as a digital processor, this is for exemplary purposes and embodiments of the control device 32 may also be embodied as an analog circuit.

In the exemplary embodiment, the control device 32 includes a controller 36 having a processor 38 and memory 40. The controller 36 is coupled to transmit a signal to the switch 26 and cause the switch 26 to move between the first state and the second state. The memory 40 may include one or more types of memory, including random access memory (RAM), non-voltile memory (NVM) or read-only memory (ROM).

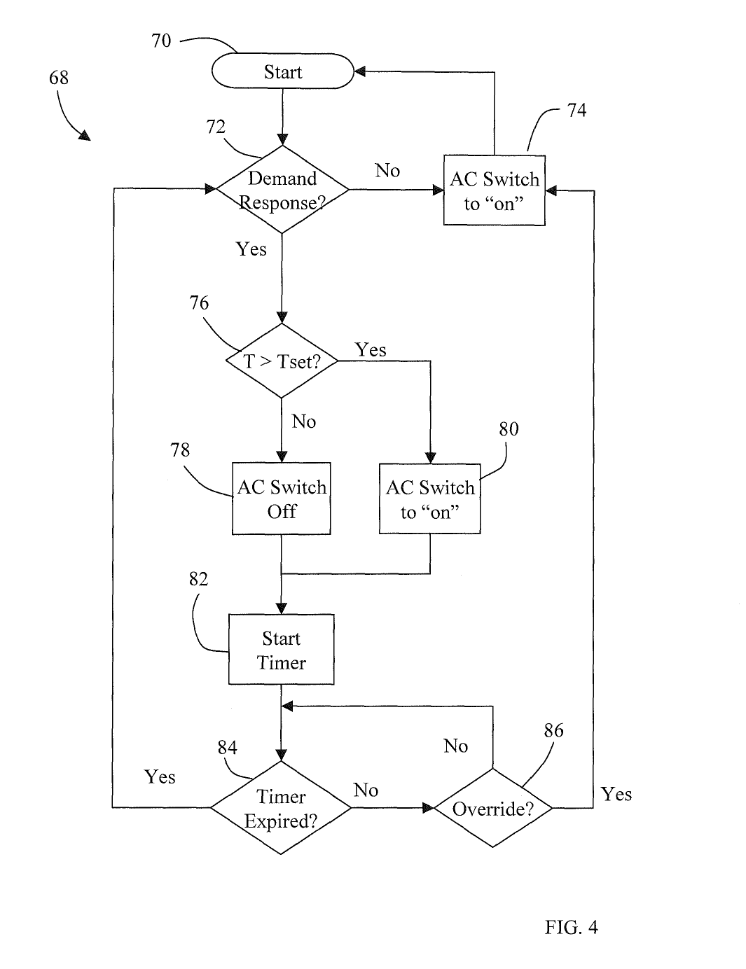

The controller 36 includes operation control methods embodied in application code, such as that illustrated in FIG. 4 for example. These methods are embodied in computer instructions written to be executed by the processor 38, typically in the form of software. The software can be encoded in any language, including, but not limited to, assembly language, VHDL (Verilog Hardware Description Language), VHSIC HDL (Very High Speed IC Hardware Description Language), Fortran (formula translation), C, C++, Visual C++, Java, ALGOL (algorithmic language), BASIC (beginners all-purpose symbolic instruction code), visual BASIC, ActiveX, HTML (HyperText Markup Language), and any combination or derivative of at least one of the foregoing. Additionally, an operator can use an existing software application such as a spreadsheet or database and correlate various cells with the variables enumerated in the algorithms. In one embodiment, the controller 36 includes an imbedded web server that allows service personnel to communicate with the controller 36 from remote locations. Furthermore, the software can be independent of other software or dependent upon other software, such as in the form of integrated software.

As will be discussed in more detail below, the user may interact with the controller 36 via the user interface 34. In the exemplary embodiment, the user interface 34 includes a digital display 42 that displays the current set point defined by the user. The user interface 34 may also include buttons or actuators, such as first actuator 44 and a second actuator 46 for example. The user depresses the actuators 44, 46 to raise and low the desired set point. The user interface 34 may further have an override button or selector that allows the user to bypass the control functionality of the controller 36 and moves the switch 26 to the closed state.

Control device 32 further includes a temperature sensor 48 that measures the ambient temperature of the environment in which the power outlet device is located. The temperature sensor 48 transmits a signal to the controller 36 that indicates the ambient temperature. In one embodiment, the temperature sensor 48 may be a thermocouple or a thermistor for example. In another embodiment, the temperature sensor 48 may be bimetal strip coupled to a mercury switch.

The control device 32 further includes a communications device 50 that is coupled to send and receive signals from the controller 36. In the exemplary embodiment, the communications device 50 provides a means for the controller 36 to communicate signals embodying information on communications carriers as will be described in more detail herein. The communications device 50 may incorporate any type of communications protocol capable of allowing the controller 36 to receive, transmit and exchange information with one or more external devices. Communications device 50 may use wireless communication systems, methodologies and protocols such as, but is not limited to, IEEE 802.11, IrDA, infrared, radio frequency, electromagnetic radiation, microwave, Bluetooth, and laser. Further, communications device 50 may include one or more wired communications systems, methodologies and protocols such as but not limited to: TCP/IP, RS-232, RS-485, Modbus, power-line, telephone, local area networks, wide area networks, Ethernet, cellular, and fiber-optics.

In the exemplary embodiment, the communications device 50 may include one or more communications circuits or devices, such as IEEE 802.11 device commonly referred to as Wifi, a satellite device, a CDMA compliant cellular device, a GSM compliant cellular device, a radio frequency device, a IEEE 802.15.4 device commonly referred to as Zigbee, and a Bluetooth compliant device. In the exemplary embodiment, the communications device 50 is an IEEE 802.15.4 device that communicates with a home area network. In another embodiment, the satellite device transmits data on a frequency range of 3 to 40 gigahertz. In another embodiment, the radio frequency device transmits on a frequency range of 30 kilohertz to 3000 megahertz. The controller 36 may further include an optional antenna to assist in the transmission to the communication medium or carrier.

In one embodiment, the control device 32 may also include a timer 52. As will be discussed in more detail below, the timer 52 is activated when the switch 26 is move between the first state and the second state. The timer 52 measures a predetermined amount of time, such as ten (10) minutes for example, and is used to prevent the power outlet device 20 from repeatedly cycling the electrical power to the air conditioning appliance 30 at a shorter than desired interval. It is believed that repeated cycling of the air conditioning appliance 30 may result in unnecessary wear on the air conditioner compressor and other internal components. It should be appreciated that while the timer 52 is illustrated as separate from the controller 36, the timer 52 may be embodied in software executed on the processor 38, on a separate processor (not shown), or as an analog circuit.

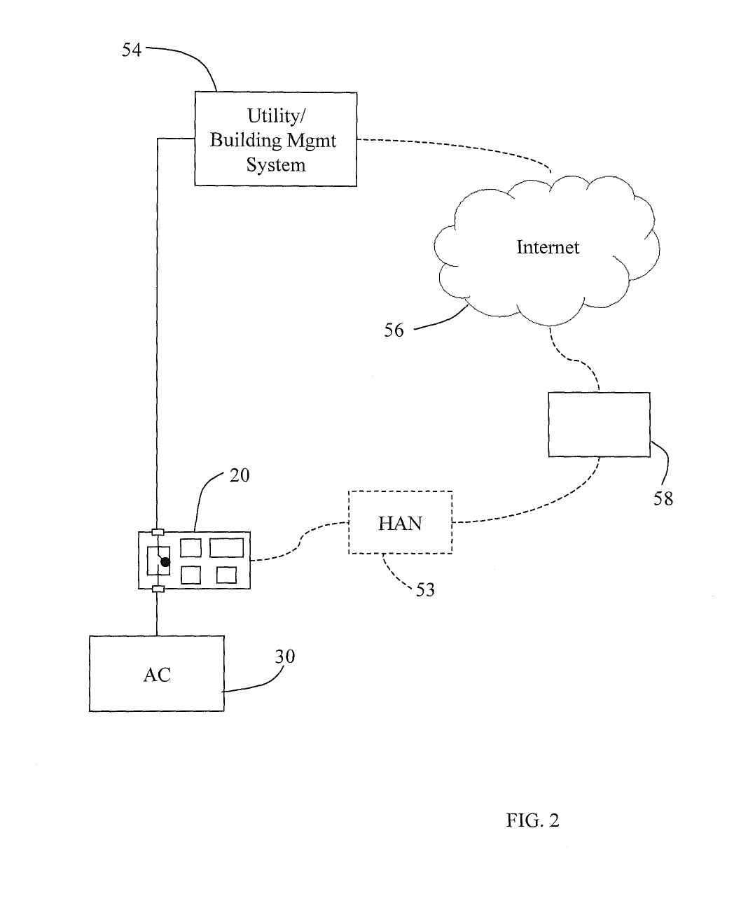

In operation, the power outlet device 20 is plugged into a wall outlet 28 as illustrated in FIG. 2. The power outlet device 20 communicates with communication device 50 with a home area network 53 using a communications protocol such as IEEE 802.15.4 for example. This provides two-way communications that allow the power outlet device 20 to transmit signals, such as the temperature set point or switch 26 state for example, and to receive signals. In one embodiment, the utility or electric power provider may have a program sometimes referred to as a “demand response program” for lowering energy consumption during peak periods to reduce the stresses on the electrical network. In this embodiment an external party, such as utility 54 for example, transmits a signal via the Internet 56. The signal is addressed to the power outlet device 20 and is received via a computer or router 58. The router 58 transmits the signal via the home area network 53 to the power outlet device 20. As will be discussed in more detail below, when the power outlet device 20 receives the signal, the power outlet device 20 will selectively couple and decouple electrical power to the air conditioning appliance 30. It should be appreciated that while embodiments herein describe the external party transmitting the signal as a utility, the claimed invention should not be so limited and the transmitting entity may be a public utility, an energy provider, a power aggregator, a building owner, or a building manager for example. In one embodiment, the signal may be transmitted or originate from a building management system.

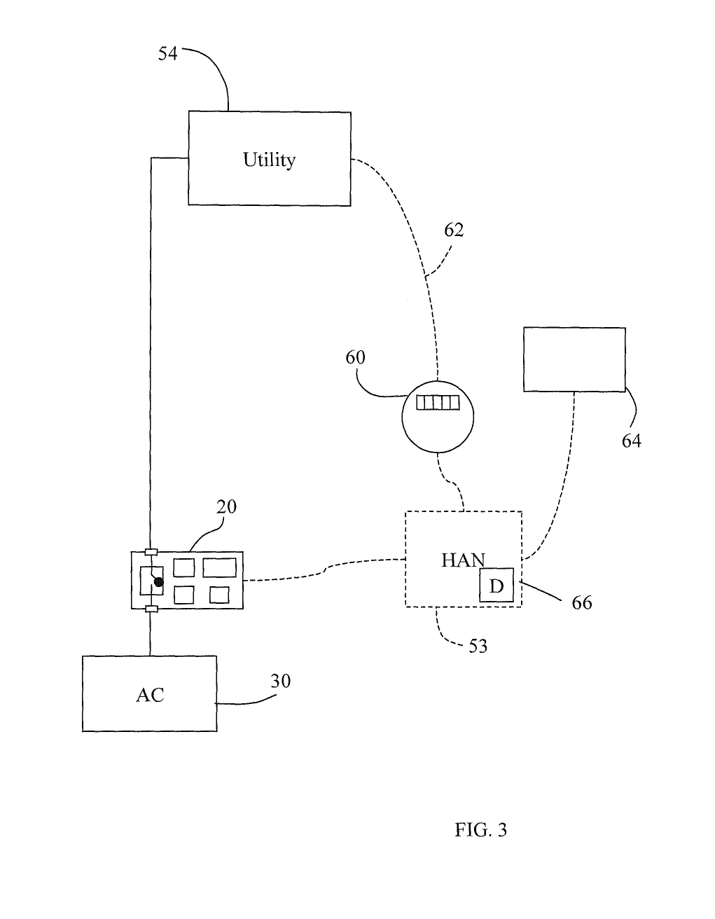

Another embodiment where the power outlet device 20 receives a signal from an external party, such as utility 54 for example, is illustrated in FIG. 3. In this embodiment, the utility 54 includes an infrastructure that allows for two-way communication with electrical meters 60. In one embodiment, the electrical meter is an Advanced Metering Infrastructure (“AMI”). The AMI meter 60 has a processing and communication circuits that allow the meter 60 to communicate information and receive instructions from the utility 54. The meter 60 further has communications circuitry to communicate with the home area network 53. This may allow the customer to control or monitor their electrical consumption in real-time or near-real time such as with a person computer 64 or a mobile device (e.g. cell phone) for example. The communications between the meter 60 and the home area network 53 may be wireless, using a protocol such as IEEE 802.15.4 (e.g. Zigbee) for example, or using a wired connection such as Ethernet or powerline carrier systems for example.

When the utility desires to reduce demand on the electrical grid, a first signal is transmitted from the utility 52 through the communications infrastructure 62 to the meter 60. The meter 60 receives the first signal from the utility and transmits a second signal to the power outlet device 20 via the home area network 53. In one embodiment, the second signal may pass through an intermediary device 66 connected to the home area network 53. The intermediary device 66 may be a home energy monitor 66 or base unit that allows the user to monitor and/or control appliances to reduce energy consumption. When the power outlet device 20 receives the signal, the power outlet device 20 will selectively couple and decouple electrical power to the air conditioning appliance 30 to reduce electrical consumption as will be discussed in more detail below.

Referring now to FIG. 4, a method 68 of operating the power outlet device 20 will be described. The method 68 starts in block 70 and proceeds to query block 72 where it is determined if there is a demand response signal from the utility or energy provider. As discussed above, the demand response signal may come from any source that the user provides access, such as the electrical utility, a power aggregator or even the user themselves. In one embodiment, the signal may be transmitted by the user remotely via their cellular phone or other wireless device for example. If the query block 72 returns a negative, the method 68 proceeds to block 74 where the switch 26 is set to the closed or connected state and the method 68 loops back to start block 70.

If query block 72 returns a positive, meaning that a signal has been received, the method 68 proceeds to query block 76 where it is determined if the temperature at the power outlet measured by sensor 48 is greater than the temperature Tₛₑₜ defined by the user via user interface 34. It should be appreciated that if the user defines Tₛₑₜ to be a higher temperature than the normal operating temperature of the air conditioning appliance, then there will be a reduction in electrical usage by the air conditioning appliance. If the query block 72 returns a negative, meaning the measured temperature is less than Tₛₑₜ, then the method 68 proceeds to block 78 where a where the switch 26 is moved to the open state and the power to the air conditioning appliance is halted. If the query block 72 returns a positive, meaning the measured temperature is greater than Tₛₑₜ, then the method 68 proceeds to block 80 where the switch 26 is closed allowing electrical power to flow to the air conditioning appliance. It should be appreciated that if the switch 26 is already in the desired position or state when the method 68 reaches block 74, block 78 or block 80, then the switch 26 simply remains in the desired position.

After completing block 78 or block 80, the method proceeds to block 82 where the timer 52 is initiated. It has been found that repeated cycling of the power to an air conditioning appliance may result in unnecessary wear on the appliances components, such as the compressor for example. Therefore, the timer 52 is initiated to allow a predetermined amount of time to elapse before the state of switch 26 may be changed. In the exemplary embodiment, the timer 52 is set for ten (10) minutes.

Once the timer 52 is initiated, the method 68 proceeds to query block 84 where it is determined if the timer 52 has expired. If the query block 84 returns a positive, meaning the timer 52 expired, then the method 68 loops back to query block 72 to determine if the demand response or demand curtailment is still desired. If the query block 84 returns a negative, then method 68 proceeds to query block 86 where it is determined if the customer has overridden the set temperature. In one embodiment, the power outlet device 20 has an override selector that allows the user to prevent the device 20 from turning the air conditioner appliance off. If the query block 86 returns a positive, the method 68 loops back to block 74 where the state of the switch 26 is set to the closed state or position. If the query block 86 returns a negative, the method 68 loops back to query block 84 until the timer 52 expires.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A power outlet device comprising:
a power inlet;
a switch electrically coupled to said power inlet, said switch having a first open position and a second closed position;
a power outlet electrically coupled to said switch;
a controller operably coupled to said switch to selectively move said switch between said first open position and said second closed position;
a temperature sensor operably coupled to said controller; and,
a communications circuit operably coupled to said controller.

2. The power outlet device of claim 1 further comprising a user interface operably coupled to said controller.

3. The power outlet device of claim 2 wherein said controller includes a timer, said controller initiating said timer when said switch is moved from said second closed position to said first open position.

4. The power outlet device of claim 3 wherein said switch moves from said first position to said second position in response to a signal from said user interface.

5. The power outlet device of claim 4 wherein said timer circuit measures a predetermined amount of time.

6. The power outlet device of claim 3 wherein said timer is associated with a home area network device.

7. A power outlet device comprising:
a switch being movable between a first state and a second state; and,
a controller operably coupled to said switch;
a temperature sensor operably coupled to said controller; and,
a communications device operably coupled to said controller;
wherein said controller includes a processor responsive to executable computer instructions when executed on said processor for moving said switch between said first state and said second state in response to a first signal from said communications device when said temperature sensor measures a temperature less than a predetermined set point.

8. The power outlet device of claim 7 wherein said processor is further responsive to executable computer instructions when executed on said processor for initiating a timer in response to said switch is moving between said first state and said second state.

9. The power outlet device of claim 8 further comprising a user interface electrically coupled to said controller.

10. The power outlet device of claim 9 wherein said user interface includes a digital display and at least one actuator.

11. The power outlet device of claim 9 wherein said predetermined set point is user selectable via said user interface.

12. The power outlet device of claim 11 wherein said processor is further responsive to executable computer instructions when executed on said processor for moving said switch between said first state and said second state in response to a second signal from said user interface.

13. The power outlet device of claim 12 wherein said communications device complies with an IEEE 802.15.4 standard.

14. A method of operating an air conditioning unit comprising:
electrically coupling said air conditioning unit to a power outlet device having a switch arranged to electrically couple and decouple said air conditioning unit from an electrical circuit;
selecting a set point temperature with a user interface operably coupled to said power outlet device;
measuring an ambient temperature with a temperature sensor operably coupled to said power outlet device;
receiving a wireless command signal at said power outlet device; and,
decoupling said air conditioning unit from said electrical circuit with said switch in response to said wireless command signal when said measured temperature is less than said set point temperature.

15. The method of claim 14 further comprising initiating a timer for a predetermined amount of time when said switch decouples said air conditioning unit from said electrical circuit.

16. The method of claim 15 further comprising coupling said air conditioning unit to said electrical circuit with said switch in response to a signal from said user interface.

17. The method of claim 16 further comprising:
determining if said predetermined amount of time on said timer had elapsed; and,
coupling said air conditioning unit to said electrical circuit with said switch in response to said predetermined amount of time elapsing on said timer.

18. The method of claim 17 wherein said predetermined amount of time is 10 minutes.

19. The method of claim 18 wherein said user interface includes a display, and further comprising displaying said set point temperature on said display.

20. The method of claim 19 further comprising receiving said set point temperature from a remote computer.

21. A power outlet device for an air conditioner comprising:
a power inlet configured to be removably connected to said air conditioner;
a switch electrically coupled to said power inlet, said switch having a first open state and a second closed state;
a power outlet electrically coupled to said switch;
a controller operably coupled to said switch to selectively change said switch between said first open state and said second closed state;
a temperature sensor electrically coupled to said controller;
a communications device electrically coupled to said controller; and,
a timer operably coupled to said controller, said timer being configured to initiate when said switch changes from said second closed state to said first open state.

22. The device of claim 21 further comprising a user interface electrically coupled to said controller, said user interface having a first actuator, wherein said controller is configured to change a temperature set point in response to an actuation of said first actuator.

23. The device of claim 22 wherein said user interface further includes a second actuator, wherein said controller is configured to change a temperature set point in response to said second actuator.

24. The device of claim 23 wherein said user interface further includes an override selector.

25. The device of claim 24 wherein said controller includes a processor responsive to executable computer instructions when executed on said processor for changing said switch from said second closed state and said first open state in response to a demand response signal from said communications device when said temperature sensor measures a temperature less than said temperature set point.

26. The device of claim 25 wherein said processor is further responsive to executable instructions for changing said switch from said first open state and said second closed state in response to a signal from said override selector.

27. The device of claim 25 wherein said processor is further responsive to executable computer instructions for changing said switch from said first open state to said second closed state in response to said timer expiring and said temperature sensor measuring a temperature greater than said temperature set point.

28. A method of operating an air conditioning unit comprising:
electrically coupling said air conditioning unit to a power outlet device having a switch arranged to electrically couple and decouple said air conditioning unit from an electrical circuit;
selecting a set point temperature with an actuator on said power outlet device;
measuring an ambient temperature with a temperature sensor;
receiving a demand response signal at said power outlet device; and,
decoupling said air conditioning unit from said electrical circuit with said switch in response to said demand response signal when said measured temperature is less than said set point temperature;
initiating a timer when said switch decouples said air conditioning unit from said electrical circuit.

29. The method of claim 28 further comprising:
determining when said predetermined amount of time on said timer expires; and,
coupling said air conditioning unit to said electrical circuit with said switch in response to expiration of said timer and said measured temp being greater than said set point temperature.

30. The method of claim 29 further comprising coupling said coupling said air conditioning unit to said electrical circuit with said switch in response to a user actuating an override selector.

31. The method of claim 28 wherein said demand response signal is transmitted by a user from a wireless device.

32. The method of claim 14 wherein said wireless command signal is transmitted by a user from a wireless device.
